(19) United States
(12) Patent Application Publication
(10) Pub. No.: US 2010/0309169 A1
(43) Pub. Date: Dec. 9, 2010

(54) Optical Touch Screen with Reflectors

(75) Inventors: Klony Lieberman, Jerusalem (IL); Dan Gunders, Tel Aviv (IL)

Correspondence Address: KLONY LIEBERMAN;LUMIO INC., 4 Hamaayan st, Ligad Center 2, Modiin, IL

(73) Assignee: LUMIO INC., Woodland Hills, CA (US)

(21) Appl. No.: 12/792,754

(22) Filed: Jun. 3, 2010

Related U.S. Application Data
(60) Provisional application No. 61/311,401, filed on Mar. 8, 2010.
(60) Provisional application No. 61/183,565, filed on Jun. 3, 2009.

(51) Int. Cl. G06F 3/042

(52) U.S. Cl. 345/175

(57) ABSTRACT

A touch panel including a generally planar surface, at least two illuminators, for illuminating a sensing plane generally parallel to the generally planar surface, at least one selectably actuable reflector operative, when actuated, to reflect light from at least one of the at least two illuminators, at least one sensor for generating an output based on sensing light in the sensing plane and a processor which receives the output from the at least one sensor, and provides a touch location output indication.

### REFERENCE TO RELATED APPLICATIONS

Reference is hereby made to the following related applications:

U.S. Provisional Patent Application Ser. No. 61/183,565, filed Jun. 3, 2009, entitled OPTICAL TOUCH SCREEN WITH REDUCED NUMBER OF SENSORS, the disclosure of which is hereby incorporated by reference and priority of which is hereby claimed pursuant to 37 CFR 1.78(a)(4) and (5)(i);

U.S. Provisional Patent Application Ser. No. 61/311,401, filed Mar. 8, 2010, entitled OPTICAL TOUCH SCREEN WITH MULTIPLE REFLECTOR TYPES, the disclosure of which is hereby incorporated by reference and priority of which is hereby claimed pursuant to 37 CFR 1.78(a)(4) and (5)(i);

U.S. patent application Ser. No. 12/027,293, filed Feb. 7, 2008, entitled OPTICAL TOUCH SCREEN ASSEMBLY; and

U.S. Pat. No. 7,477,241, issued Jan. 13, 2009, entitled DEVICE AND METHOD FOR OPTICAL TOUCH PANEL ILLUMINATION.

### FIELD OF THE INVENTION

The present invention relates to optical touch panels generally.

### BACKGROUND OF THE INVENTION

The following U.S. patent publications are believed to represent the current state of the art:

U.S. Pat. No. 6,954,197.

### SUMMARY OF THE INVENTION

The present invention seeks to provide improved optical touch panels. There is thus provided in accordance with a preferred embodiment of the present invention a touch panel including a generally planar surface, at least two illuminators, for illuminating a sensing plane generally parallel to the generally planar surface, at least one selectably actuable reflector operative, when actuated, to reflect light from at least one of the at least two illuminators, at least one sensor for generating an output based on sensing light in the sensing plane and a processor which receives the output from the at least one sensor, and provides a touch location output indication.

Preferably, the output from the at least one sensor indicates angular regions of the sensing plane in which light from the at least one illuminator is blocked by the presence of at least one object in the sensing plane and the processor includes functionality operative to associate at least one two-dimensional shape to intersections of the angular regions, choose a minimum number of the at least one two-dimensional shape sufficient to represent all of the angular regions and calculate at least one location of the presence of the at least one object with respect to the generally planar surface based on the minimum number of the at least one two-dimensional shape. Additionally, the at least one object includes at least two objects, the at least one two-dimensional shape includes at least two two-dimensional shapes, the minimum number of the at least one two-dimensional shape includes at least two of the at least one two-dimensional shape and the at least one location includes at least two locations.

In accordance with a preferred embodiment of the present invention the functionality is operative to select multiple actuation modes of the at least one selectably actuable reflector to provide the touch location output indication. Additionally, at least one of the at least two illuminators is selectably actuable and the object impingement shadow processing functionality is operative to select corresponding multiple actuation modes of the at least one selectably actuable illuminator. Additionally, the object impingement shadow processing functionality is operative to process outputs from selected ones of the at least one sensor corresponding to the multiple actuation modes of the at least one selectably actuable illuminator for providing the touch location output indication.

Preferably, the touch location output indication includes a location of at least two objects.

There is also provided in accordance with another preferred embodiment of the present invention a touch panel including a generally planar surface, at least one illuminator for illuminating a sensing plane generally parallel to the generally planar surface, at least one sensor for sensing light from the at least one illuminator indicating presence of at least one object in the sensing plane and a processor including functionality operative to receive inputs from the at least one sensor indicating angular regions of the sensing plane in which light from the at least one illuminator is blocked by the presence of the at least one object in the sensing plane, associate at least one two-dimensional shape to intersections of the angular regions, choose a minimum number of the at least one two-dimensional shape sufficient to represent all of the angular regions and calculate at least one location of the presence of the at least one object with respect to the generally planar surface based on the minimum number of the at least one two-dimensional shape.

Preferably, the touch panel also includes at least one reflector configured to reflect light from the at least one illuminator. Additionally, the at least one reflector includes a 1-dimensional retro-reflector. In accordance with a preferred embodiment of the present invention the at least one illuminator includes an edge emitting optical light guide. In accordance with a preferred embodiment of the present invention the at least one object includes at least two objects, the at least one two-dimensional shape includes at least two two-dimensional shapes, the minimum number of the at least one two-dimensional shape includes at least two of the at least one two-dimensional shape and the at least one location includes at least two locations.

There is further provided in accordance with yet another preferred embodiment of the present invention a method for calculating at least one location of at least one object located in a sensing plane associated with a touch panel, the method including illuminating the sensing plane with at least one illuminator, sensing light received by a sensor indicating angular regions of the sensing plane in which light from the at least one illuminator is blocked by the presence of the at least one object in the sensing plane, associating at least one two-dimensional shape with intersections of the angular regions, selecting a minimum number of the at least one two-dimensional shape sufficient to reconstruct all of the angular regions, associating an object location in the sensing plane with each two-dimensional shape in the minimum number of the at least one two-dimensional shape and providing a touch location output indication including the object location of the each two-dimensional shape.

Preferably, the at least one object includes at least two objects, the at least one two-dimensional shape includes at least two two-dimensional shapes, the minimum number of the at least one two-dimensional shape includes at least two of the at least one two-dimensional shape and the touch location object indication includes the at least two locations of the at least two objects.

There is even further provided in accordance with still another preferred embodiment of the present invention a touch panel including a generally planar surface, at least one illuminator, for illuminating a sensing plane generally parallel to the generally planar surface, at least one reflector operative to reflect light from the at least one illuminator, at least one 2-dimensional retro-reflector operative to retro-reflect light from at least one of the at least one illuminator and the at least one reflector, at least one sensor for generating an output based on sensing light in the sensing plane and a processor which receives the output from the at least one sensor, and provides a touch location output indication.

Preferably, the at least one illuminator includes two illuminators, the at least one 2-dimensional retro-reflector includes three 2-dimensional retro-reflectors; and the at least one sensor includes two sensors. Alternatively, the at least one reflector includes two reflectors and the at least one 2-dimensional retro-reflector includes two 2-dimensional retro-reflectors.

In accordance with a preferred embodiment of the present invention the at least one reflector includes a 1-dimensional retro-reflector.

Preferably, the output from the at least one sensor indicates angular regions of the sensing plane in which light from the at least one illuminator is blocked by the presence of at least one object in the sensing plane and the processor includes functionality operative to associate at least one two-dimensional shape to intersections of the angular regions, choose a minimum number of the at least one two-dimensional shape sufficient to represent all of the angular regions and calculate at least one location of the presence of the at least one object with respect to the generally planar surface based on the minimum number of the at least one two-dimensional shape.

In accordance with a preferred embodiment of the present invention the at least one object includes at least two objects, the at least one two-dimensional shape includes at least two two-dimensional shapes, the minimum number of the at least one two-dimensional shape includes at least two of the at least one two-dimensional shape and the touch location object indication includes the at least two locations of the at least two objects.

### BRIEF DESCRIPTION OF THE DRAWINGS

The present invention will be understood and appreciated more fully from the following detailed description, taken in conjunction with the drawings in which:

FIG. 1 is a simplified top view illustration of an optical touch panel constructed and operative in accordance with a preferred embodiment of the present invention;

FIG. 2 is a simplified perspective view illustration of two finger engagement with the optical touch panel of FIG. 1;

FIG. 3 is a simplified exploded perspective view illustration of the optical touch panel of FIGS. 1 and 2 showing additional details of the touch panel construction;

FIG. 4 is a simplified flowchart illustrating the operation of object impingement shadow processing (OISP) functionality in accordance with a preferred embodiment of the present invention;

FIG. 5 is a simplified top view illustration of an optical touch panel showing the operation of object impingement shadow processing functionality in one operational mode in accordance with a preferred embodiment of the present invention;

FIG. 6 is a simplified exploded perspective view illustration of the optical touch panel of FIG. 5 showing additional details of the touch panel construction;

FIG. 7 is a simplified top view illustration of an optical touch panel showing the operation of object impingement shadow processing functionality in another operational mode in accordance with a preferred embodiment of the present invention;

FIG. 8 is a simplified flowchart illustrating the operation of multi-stage OISP functionality in accordance with a preferred embodiment of the present invention;

FIG. 9 is a simplified top view illustration of an optical touch panel constructed and operative in accordance with another preferred embodiment of the present invention; and

FIG. 10 is a simplified top view illustration of an optical touch panel constructed and operative in accordance with yet another preferred embodiment of the present invention.

### DETAILED DESCRIPTION OF PREFERRED EMBODIMENTS

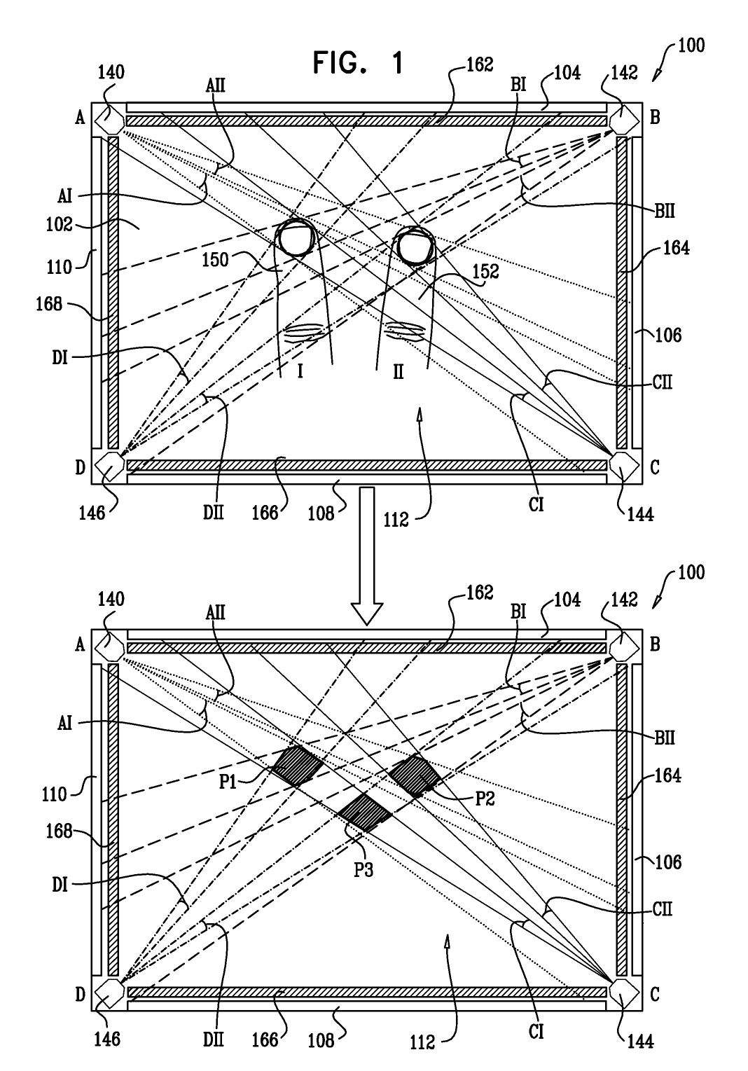

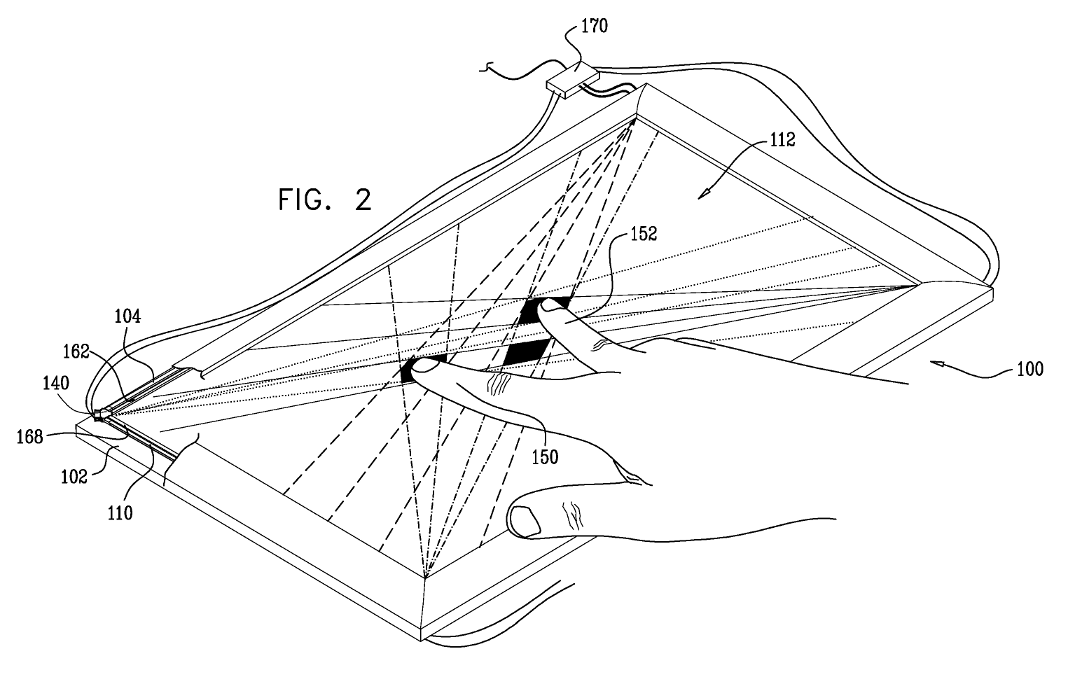

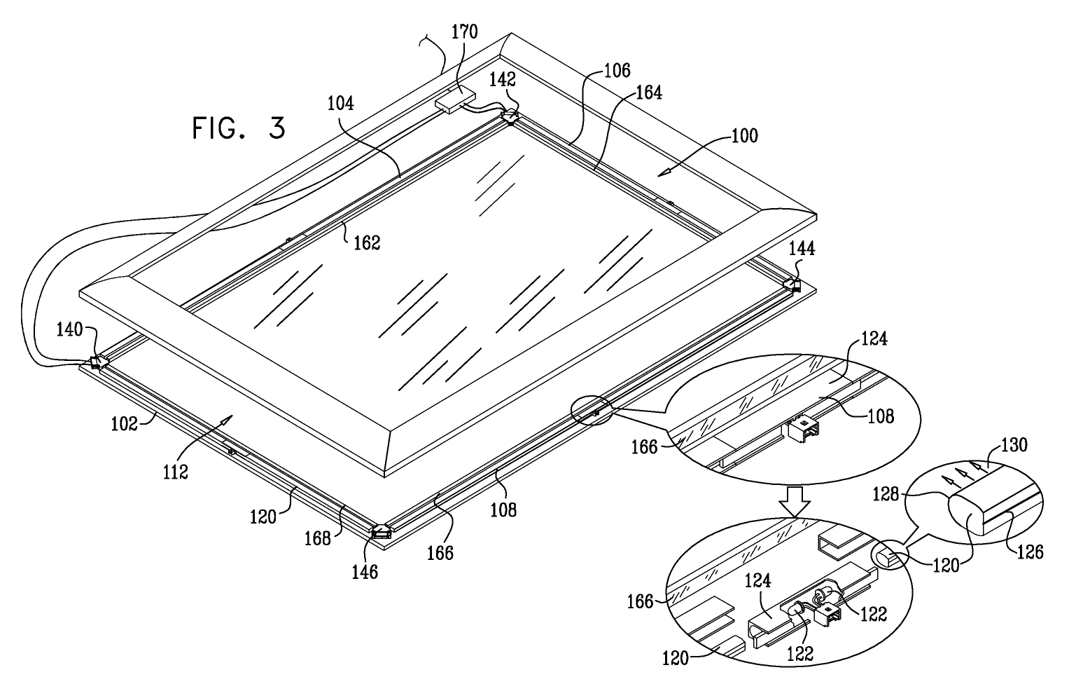

Reference is now made to FIG. 1, which is a simplified top view illustration of an optical touch panel constructed and operative in accordance with a preferred embodiment of the present invention, to FIG. 2, which is a simplified perspective view illustration of two finger engagement with the optical touch panel of FIG. 1, and to FIG. 3, which is a simplified exploded perspective view illustration of the touch panel of FIG. 1 and FIG. 2 showing additional details of the touch panel construction.

As seen in FIGS. 1-3, there is provided an optical touch panel 100 including a generally planar surface 102 and at least two illuminators, and preferably four illuminators, here designated by reference numerals 104, 106, 108 and 110, preferably, at least one, and preferably all, of which is selectably actuable, for illuminating a sensing plane 112 generally parallel to the generally planar surface 102. The illuminators are preferably comprised of assemblies containing at least one edge emitting optical light guide 120.

In accordance with a preferred embodiment of the present invention the at least one edge emitting optical light guide 120 receives illumination from light sources 122, such as an LED or a diode laser, preferably an infrared laser or infrared LED. As seen in FIG. 3, light sources 122 are preferably located in assemblies 124 located along the periphery of the generally planar surface 102. In accordance with a preferred embodiment of the present invention, at least one light guide 120 is comprised of a plastic rod, which preferably has at least one light scatterer 126 at least one location therealong, preferably opposite at least one light transmissive region 128 of the light guide 120, at which region 128 the light guide 120 has optical power. A surface of light guide 120 at transmissive region 128 preferably has a focus located in proximity to light scatterer 126. In the illustrated embodiment, light scatterer 126 is preferably defined by a narrow strip of white paint extending along the plastic rod along at least a substantial portion of the entire length of the illuminator 108.

In an alternative preferred embodiment, not shown, light guide 120 and light scatterer 126 are integrally formed as a single element, for example, by co-extruding a transparent plastic material along with a pigment embedded plastic material to form a thin light scattering region 126 at an appropriate location along light guide 120. In accordance with a preferred embodiment of the present invention, the at least one light scatterer 126 is operative to scatter light which is received from the light source 122 and passes along the at least one light guide 120. The optical power of the light guide 120 at the at least one light transmissive region 128 collimates and directs the scattered light in a direction generally away from the scatterer 126, as indicated generally by reference numeral 130.

It is appreciated that generally every location in sensing plane 112 receives light generally from every location along the at least one light transmissive region 128. In accordance with a preferred embodiment of the present invention, the at least one light guide 120 extends generally continuously along a periphery of a light curtain area defined by the planar surface 102 and the at least one light scatterer 126 extends generally continuously along the periphery, directing light generally in a plane, filling the interior of the periphery and thereby defining a light curtain therewithin.

At least one light sensor assembly 140 and preferably three additional physical light sensor assemblies 142, 144 and 146 are provided for sensing the presence of at least one object in the sensing plane 112. These four sensor assemblies 140, 142, 144 and 146 are designated A, B, C and D, respectively. Preferably, sensor assemblies 140, 142, 144 and 146 each employ linear CMOS sensors, such as an RPLIS-2048 linear image sensor, commercially available from Panavision SVI, LLC of One Technology Place, Horner, New York.

Impingement of an object, such as a finger 150 or 152 or a stylus, upon touch surface 102 preferably is sensed by the one or more light sensor assemblies 140, 142, 144 and 146 preferably disposed at corners of planar surface 102. The sensor assemblies detect changes in the light received from the illuminators 104, 106, 108 and 110 produced by the presence of fingers 150 and 152 in the sensing plane 112. Preferably, sensor assemblies 140, 142, 144 and 146 are located in the same plane as the illuminators 104, 106, 108 and 110 and have a field of view with at least 90 degree coverage.

In accordance with a preferred embodiment of the present invention there is provided at least one, and preferably four, partially transmissive reflectors, such as mirrors 162, 164, 166 and 168 disposed intermediate at least one, and preferably all four, selectably actuable illuminators 104, 106, 108 and 110 and the sensing plane 112. In a preferred embodiment of the present invention, at least one, and most preferably all four, of the reflectors are selectably actuable.

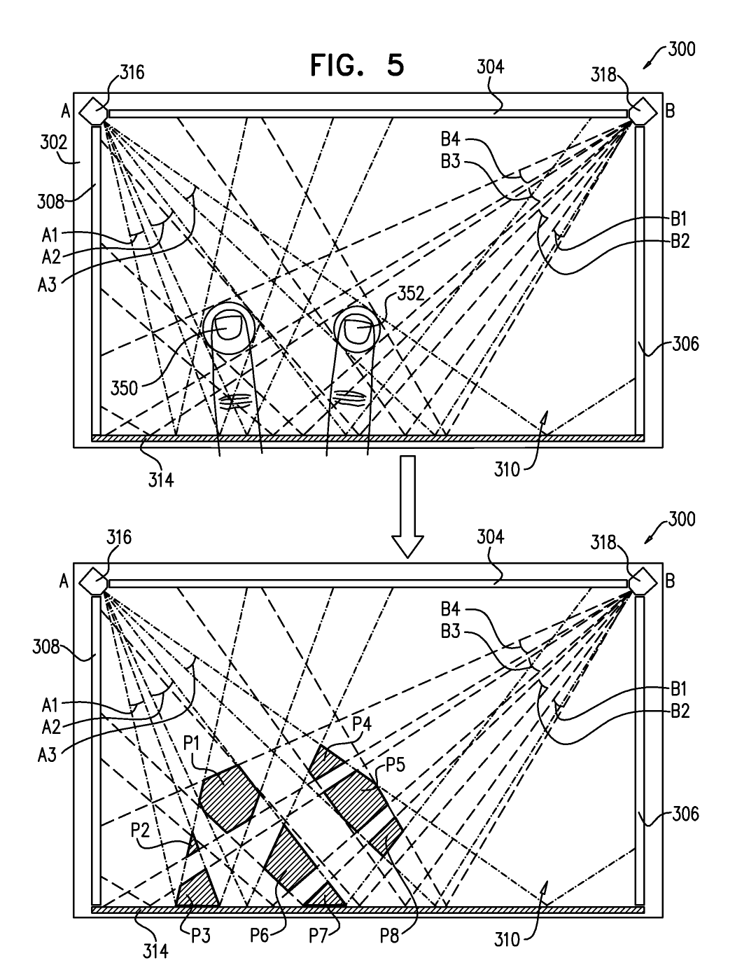

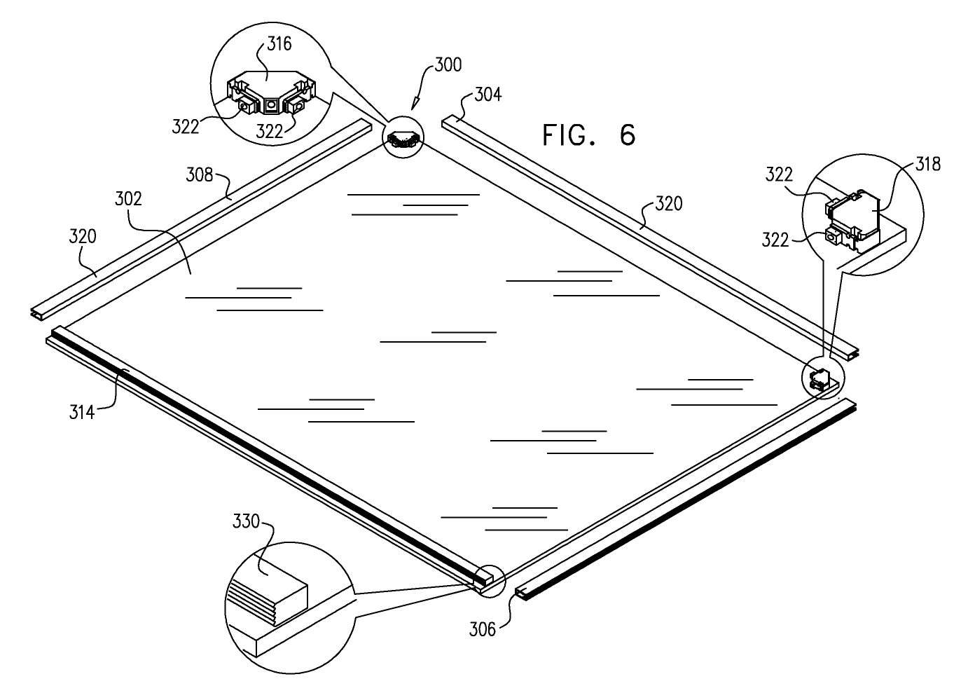

As described further hereinbelow with reference to FIGS. 5 and 6, the provision of at least one mirror results in the sensor sensing both the generated light from the illuminators that directly reaches the sensor as well as, additionally, the light generated by the illuminators and reflected from the reflectors in the sensing plane.

It is appreciated that alternatively one or more of mirrors 162, 164, 166 and 168 may be fully reflective. In such a case, the illuminator lying behind such mirror is obviated. In another alternative embodiment, all of mirrors 162, 164, 166 and 168 may be obviated.

In accordance with a preferred embodiment of the present invention there is provided a processor 170 which receives inputs from the at least one sensor and provides a touch location output indication.

Turning particularly to FIGS. 1 and 2, there is seen a diagram of finger engagement with the touch panel in an operational mode wherein all of illuminators 104, 106, 108 and 110 are actuated, and all of mirrors 162, 164, 166 and 168 are not actuated. In this operational mode four sensor assemblies 140, 142, 144 and 146 and four illuminators 104, 106, 108 and 110 are operative. It is appreciated that this is equivalent to an embodiment where no mirrors are provided.

FIGS. 1 and 2 illustrate operation of object impingement shadow processing (OISP) functionality, preferably implemented by processor 170. The OISP functionality is operative to distinguish between actual object engagements and spurious object engagements resulting from shadows sensed by sensor assemblies 140, 142, 144 and 146.

The OISP functionality is described hereinbelow, with particular reference to FIGS. 1 & 2, which illustrate four sensor assemblies 140, 142, 144 and 146, which are labeled A, B, C and D, respectively. Two objects, such as fingers 150 and 152, here also respectively designated as fingers I and II, of a user, engage the touch panel 100, as illustrated. The presence of fingers 150 and 152 causes shadows to appear in angular regions of the fields of view of each of sensor assemblies 140, 142, 144 and 146. The angular regions in the respective fields of view of each of sensor assemblies 140, 142, 144 and 146 produced by engagement of each of fingers 150 and 152 are designated by indicia referring both to the sensor assembly and to the finger. Thus for example, angular region CII refers to an angular region produced by engagement of finger II as seen by sensor assembly C.

It is appreciated that the intersections of the angular regions of all four sensor assemblies 140, 142, 144 and 146 define polygonal shadow intersection regions which constitute possible object engagement locations. These polygonal shadow intersection regions are labeled by the indicia of the intersecting angular locations which define them. Thus, the polygonal shadow intersection regions are designated as follows: AIBICIDI; AIIBIICIIDII and AIBIICIDII and are also labeled as regions P1, P2 and P3, respectively. It is further appreciated that there may be more polygonal shadow intersection regions, corresponding to possible object engagement locations, than there are actual object engagement locations. Thus, in the illustrated example of FIGS. 1 and 2, there are three polygonal shadow intersection regions, corresponding to three potential object engagement locations, yet only two actual object engagement locations.

The OISP functionality of the present invention is operative to identify the actual object engagement locations from among a greater number of potential object engagement locations.

Preferably, the OISP functionality is operative to find the smallest subset of possible object impingement locations from among the set of all potential polygonal shadow intersection regions, which subset is sufficient, such that if object impingements occur in only those regions, the entire set of all potential polygonal shadow intersection regions is generated.

In the illustrated embodiment, the OISP functionality typically operates as follows:

An investigation is carried out for each combination of two or more of the potential polygonal shadow intersection regions P1, P2 and P3 to determine whether object impingement thereat would result in creation of all of the potential polygonal shadow intersection regions P1; P2 and P3. This investigation can be carried out with the use of conventional ray tracing algorithms.

In the illustrated embodiment, the investigations indicate that object impingement at both of potential polygonal shadow intersection regions P1 and P2 does not create potential polygonal shadow intersection region P3. Similarly, the investigations indicate that that object impingement at both of potential polygonal shadow intersection regions P2 and P3 does not create potential polygonal shadow region P1. The investigation indicates that object impingement at both of potential polygonal shadow intersection regions P1 and P2 does create potential polygonal shadow region P3.

Accordingly it is concluded that potential polygonal shadow region P3 does not correspond to an actual object impingement location. It is appreciated that it is possible, notwithstanding, that potential polygonal shadow region P3 does correspond to an actual object impingement location.

It is appreciated that the probability of an additional object being present in a precise location such that it is completely encompassed by one of the spurious polygon shadow regions is generally quite small so that the OISP functionality can ignore this possibility with a high level of confidence. It is further appreciated that it is generally preferable to miss recording an event than to erroneously output a non-existent event.

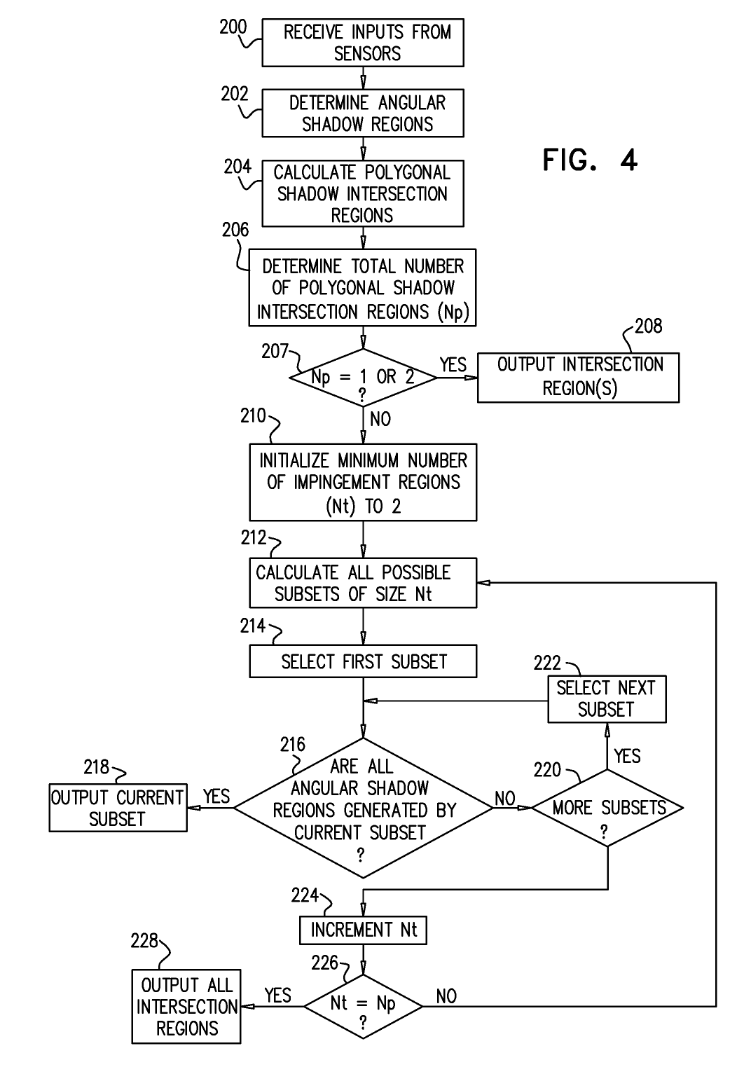

It is appreciated that the OISP functionality described above and further hereinbelow with reference to FIG. 4, is operative to deal with up to any desired number of simultaneous object impingements.

It is further appreciated that de-actuation of a selectably acutable mirror can be accomplished by activating the illuminator behind mirror with sufficient intensity such that the additional light reflected by the partially reflecting mirror can be ignored or filtered out. It is further appreciated that de-actuation of a mirror can be accomplished by mechanical means that tilt or move the mirror sufficiently to direct the reflected light out of the sensing plane so it will not impinge on the sensor.

Reference is now made to FIG. 4, which is a simplified flowchart of the OISP functionality of the present invention. As seen in FIG. 4, in step 200, a processor, such as processor 170, is operative to receive inputs from one or more sensor assemblies, such as sensor assemblies 140, 142, 144 and 146. In step 202, the processor uses the output of each of sensor assemblies 140, 142, 144 and 146 to determine angular shadow regions associated with each sensor assembly. The processor is then operative, in step 204, to calculate polygonal shadow intersection regions, such as regions P1, P2 and P3. The processor is then operative, in step 206, to determine the total number of polygonal shadow intersection regions (Np).

It is appreciated that a single object will produce a single polygonal shadow intersection region and that two polygonal shadow intersection regions can only be produced by impingement of two objects at those two polygonal shadow intersection regions. The processor therefore tests, as step 207, if the total number of polygonal shadow intersection regions, Np, is equal to one or two. When Np is one, the processor is operative, in step 208, to output the corresponding region as the single object impingement location. When Np is two, the processor is operative, in step 208, to output the corresponding intersection regions as the two object impingement locations.

When Np is greater than two, the processor is then operative, in step 210 to initialize a counter for the minimum number of impingement regions (Nt) to 2. The processor, in step 212, calculates all possible subsets of size Nt of the polygonal shadow intersection regions. It is appreciated that the number of possible subsets of size Nt is given by the combinatorial function Np!(Np−Nt)!/Nt!.

The processor is then operative to test each of the subsets of possible object engagement locations of size Nt to find a subset such that, if object impingements occur in only the regions in that subset, the entire set of all potential polygonal shadow intersection regions is generated.

Thus, in step 214, the first subset is selected. It is appreciated that the processor may be operative to select the first subset based on the Nt largest polygon regions. Alternatively, the processor may select the first Nt polygons as the first subset. Alternatively, the processor may select any of the subsets as the first subset. The current subset is then tested at step 216 to see if impingement at the intersection regions in the current subset generates all angular shadow regions generated in step 202. If all angular shadow regions generated in step 202 are generated by the current subset, the processor is operative, in step 218, to output the intersection regions identified by the current subset as the Nt object impingement locations.

If all angular shadow regions generated in step 202 are not generated by the current subset, the processor is operative, in step 220, to check if the current subset is the last subset of size Nt. If there are subsets of size Nt remaining to be tested, the next subset of size Nt is selected in step 222 and the process return to step 216 to test the next subset. If there are no more subsets of size Nt remaining, the processor is operative, at step 224 to increment Nt.

The processor then tests if Nt is equal to Np at step 226. If Nt equals Np, the processor is operative, in step 228, to output all of the intersection regions identified as the Np object impingement locations. If Nt does not equal Np, the processor is operative to return to step 212 to then test all subsets of size Nt.

Reference is now made to FIG. 5, which is a simplified top view illustration of an optical touch panel constructed and operative in accordance with another preferred embodiment of the present invention, and to FIG. 6, which is a simplified exploded perspective view illustration of the optical touch panel of FIG. 5 showing additional details of the touch panel construction.

As seen in FIGS. 5 and 6, there is provided an optical touch panel 300 including a generally planar surface 302 and three illuminators 304, 306 and 308 for illuminating a sensing plane 310 generally parallel to the generally planar surface 302. Optical touch panel 300 also includes a mirror 314 and two sensor assemblies 316 and 318. Optical touch panel 300 also includes a processor (not shown), similar to processor 170 of touch panel 100 of FIGS. 1-3, which receives inputs from sensor assemblies 316 and 318 and provides a touch location output indication utilizing Object Impingement Shadow Processing functionality.

It is appreciated that optical touch panel 300 of FIG. 5 is functionally equivalent to touch panel 100 of FIGS. 1-3 in an operational mode where illuminator 108 is not actuated and mirror 166 is actuated, and the outputs of sensor assemblies 140 and 142 are employed by the processor to provide a touch location output indication.

As seen in FIG. 6, illuminators 304, 306 and 308 are preferably edge emitting optical light guides 320. Edge emitting optical light guides 320 preferably receives illumination from light sources 322, such as an LED or a diode laser, preferably an infrared laser or infrared LED. As seen in FIG. 6, light sources 322 are preferably located at corners of generally planar surface 302 adjacent sensor assemblies 316 and 318.

As seen further in FIG. 6, mirror 314 is preferably a 1-dimensional retro-reflector 330 that acts as an ordinary mirror within the sensing plane but confines the reflected light to the sensing plane via the retro-reflecting behavior along the perpendicular axis.

Turning particularly to FIG. 5, there is seen a diagram of finger engagement with touch panel 300, including illuminators 304, 306 and 308, mirror 314 and sensor assemblies 316 and 318. FIG. 5 illustrates operation of object impingement shadow processing (OISP) functionality, preferably implemented by the processor. The OISP functionality is operative to distinguish between actual object engagements and spurious object engagements resulting from shadows sensed by sensor assemblies 316 and 318. It is appreciated that sensor assemblies 316 and 318 are operative to sense both direct light from illuminators 304, 306 and 308 and reflected light from mirror 314.

The OISP functionality is described hereinbelow with particular reference to FIG. 5, which illustrates two sensor assemblies 316 and 318, which are labeled A and B, respectively. Two objects, such as fingers 350 and 352 of a user, engage the touch panel 300, as illustrated. The presence of fingers 350 and 352 causes shadows to appear in angular regions of the fields of view of each of sensor assemblies 316 and 318. The angular regions in the respective fields of view of each of sensor assemblies 316 and 318 produced by engagement of each of fingers 350 and 352 are designated numerically based on the sensor assembly. Thus for example, angular regions A1, A2, A3 refer to angular regions produced by engagement of fingers 350 and 352 as seen by sensor assembly A, while angular regions B1, B2, B3 and B4 refer to angular regions produced by engagement of fingers 350 and 352 as seen by sensor assembly B.

It is appreciated that the intersections of the angular regions of sensor assemblies 316 and 318 define polygonal shadow intersection regions, designated as P1, P2, P3, P4, P5, P6, P7 and P8, which constitute possible object engagement locations. As seen in FIG. 5, polygonal shadow intersection region P1 is defined by the intersection of angular regions A1, A2, B2 and B4. It is further appreciated that there may be more polygonal shadow intersection regions, corresponding to possible object engagement locations, than there are actual object engagement locations. Thus, in the illustrated example of FIG. 5, there are eight polygonal shadow intersection regions, corresponding to eight potential object engagement locations, yet only two actual object engagement locations.

The OISP functionality of the present invention is operative to identify the actual object engagement locations from among a greater number of potential object engagement locations.

Preferably, the OISP functionality is operative to find the smallest subset of possible object engagement locations from among the set of all potential polygonal shadow intersection regions, which subset is sufficient, such that if object impingements occur in only those regions, the entire set of all potential polygonal shadow intersection regions is generated.

In the illustrated embodiment, the OISP functionality typically operates as follows:

An investigation is carried out for each combination of two or more of the potential polygonal shadow intersection regions P1, P2, P3, P4, P5, P6, P7 and P8 to determine whether object impingement thereat would result in creation of all of the potential polygonal shadow intersection regions P1, P2, P3, P4, P5, P6, P7 and P8. This investigation can be carried out with the use of conventional ray tracing algorithms

In the illustrated embodiment, the investigations indicate that object impingement at both of potential polygonal shadow intersection regions P1 and P2 does not create potential polygonal shadow intersection regions P3, P4, P5, P6, P7 and P8. Similarly, the investigations indicate that that object impingement at both of potential polygonal shadow intersection regions P1 and P3 does not create potential polygonal shadow regions P2, P4, P5, P6, P7 and P8. The investigation indicates that object impingement at both of potential polygonal shadow intersection regions P1 and P5 does create potential polygonal shadow region P2, P3, P4, P6, P7 and P8.

Accordingly it is concluded that potential polygonal shadow regions P1 and P5 correspond to actual object impingement locations and that polygonal shadow regions P2, P3, P4, P6, P7 and P8 do not correspond to an actual object impingement locations. It is appreciated that it is possible, notwithstanding, that any of potential polygonal shadow regions P2, P3, P4, P6, P7 and P8 may correspond to an actual object impingement location.

It is appreciated that the probability of an additional object being present in a precise location such that it is completely encompassed by one of the spurious polygon shadow regions is generally quite small so that the OISP functionality can ignore this possibility with a high level of confidence. It is further appreciated that it is generally preferable to miss recording an event than to erroneously output a non-existent event.

It is appreciated that the OISP functionality described above and with reference to FIG. 4 is operative to deal with up to any desired number of simultaneous object impingements.

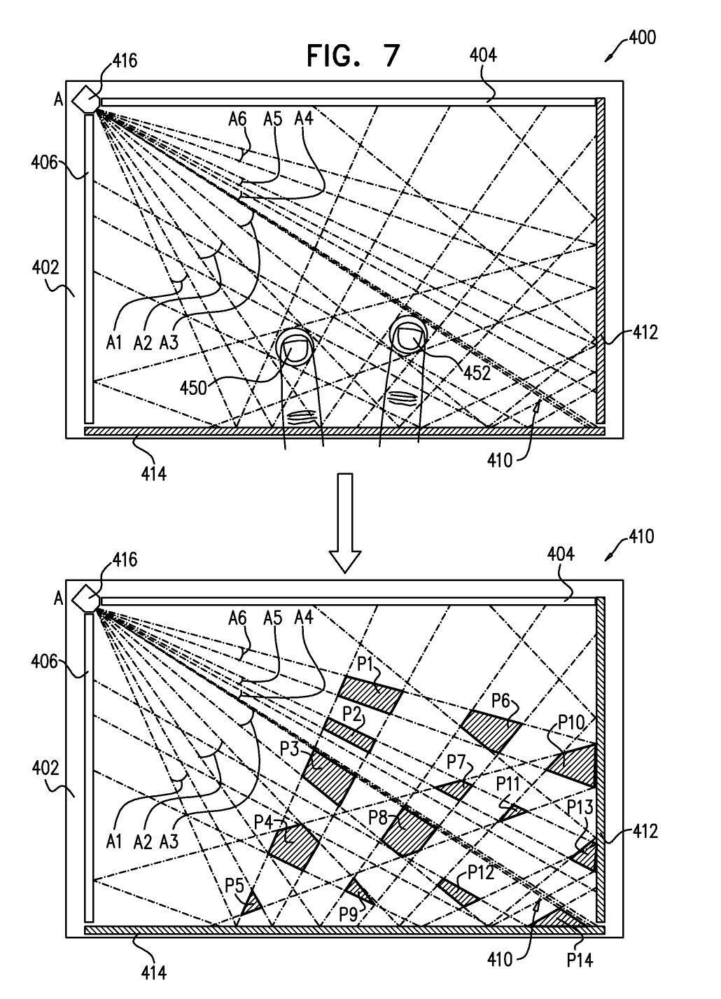

Reference is now made to FIG. 7, which is a simplified top view illustration of an optical touch panel constructed and operative in accordance with another preferred embodiment of the present invention.

As seen in FIG. 7, there is provided an optical touch panel 400 including a generally planar surface 402 and two illuminators 404 and 406 for illuminating a sensing plane 410 generally parallel to the generally planar surface 402. Optical touch panel 400 also includes two mirrors 412 and 414 and a single sensor assembly 416. Optical touch panel 400 also includes a processor (not shown), similar to processor 170 of touch panel 100 of FIGS. 1-3, which receives inputs from sensor assembly 416 and provides a touch location output indication.

It is appreciated that optical touch panel 400 of FIG. 7 is functionally equivalent to touch panel 100 of FIGS. 1-3 in an operational mode where illuminators 106 and 108 are not actuated and mirrors 164 and 166 are actuated, and the output of sensor assembly 140 is employed by the processor to provide a touch location output indication.

Turning particularly to FIG. 7, there is seen a diagram of finger engagement with touch panel 400, including illuminators 404 and 406, mirrors 412 and 414 and sensor assembly 416. FIG. 7 illustrates operation of object impingement shadow processing (OISP) functionality, preferably implemented by the processor. The OISP functionality is operative to distinguish between actual object engagements and spurious object engagements resulting from shadows sensed by sensor assembly 416. It is appreciated that sensor assembly 416 is operative to sense both direct light from illuminators 404 and 406 and reflected light from mirrors 412 and 414.

The OISP functionality is described hereinbelow with particular reference to FIG. 7, which illustrates a single sensor assembly 416, which is labeled A. Two objects, such as fingers 450 and 452 of a user, engage the touch panel 400, as illustrated. The presence of fingers 450 and 452 causes shadows to appear in angular regions of the fields of view of sensor assembly 416. The angular regions in the respective fields of view of sensor assembly 416 produced by engagement of each of fingers 450 and 452 are designated numerically as A1, A2, A3, A4, A5 and A6.

It is appreciated that the intersections of the angular regions of sensor assembly 416 define polygonal shadow intersection regions, designated as P1, P2, P3, P4, P5, P6, P7, P8, P9, P10, P11, P12, P13 and P14, which constitute possible object engagement locations. As seen in FIG. 6, polygonal shadow intersection region P1 is defined by the intersection of angular regions A1 and A6, while polygon shadow intersection region P4 located under Finger I is defined by the intersections of angular regions A1, A2 and A6. It is further appreciated that there may be more polygonal shadow intersection regions, corresponding to possible object engagement locations, than there are actual object engagement locations. Thus, in the illustrated example of FIG. 7, there are 14 polygonal shadow intersection regions, corresponding to 14 potential object engagement locations, yet only two actual object engagement locations.

The OISP functionality of the present invention is operative to identify the actual object engagement locations from among a greater number of potential object engagement locations.

Preferably, the OISP functionality is operative to find the smallest subset of possible object engagement locations from among the set of all potential polygonal shadow intersection regions, which subset is sufficient, such that if object impingements occur in only those regions, the entire set of all potential polygonal shadow intersection regions is generated.

In the illustrated embodiment, the OISP functionality typically operates as follows:

An investigation is carried out for each combination of two or more of the potential polygonal shadow intersection regions P1 through P14 to determine whether object impingement thereat would result in creation of all of the potential polygonal shadow intersection regions P1 through P14. This investigation can be carried out with the use of conventional ray tracing algorithms

In the illustrated embodiment, the investigations indicate that object impingement at both of potential polygonal shadow intersection regions P1 and P2 does not create all of the potential polygonal shadow intersection regions P3 though P14. Similarly, the investigations indicate that that object impingement at both of potential polygonal shadow intersection regions P1 and P3 does not create potential polygonal shadow regions P2 and P4 through P14. The investigation indicates that object impingement at both of potential polygonal shadow intersection regions P4 and P8 does create potential polygonal shadow regions P1-P3, P5-P7 and P9-P14.

Accordingly it is concluded that potential polygonal shadow regions P1-P3, P5-P7 and P9-P14 do not correspond to an actual object impingement location. It is appreciated that it is possible, notwithstanding, that potential polygonal shadow regions P1-P3, P5-P7 and P9-P14 do correspond to an actual object impingement location. It is appreciated that the probability of an additional object being present in a precise location such that it is completely encompassed by one of the spurious polygon shadow regions is generally quite small so that the OISF can ignore this possibility with a high level of confidence. It is further appreciated that it is generally preferable to miss recording an event than to erroneously output a non-existent event.

It is appreciated that the OISP functionality described above with reference to FIG. 4, is operative to deal with up to any desired number of simultaneous object impingements.

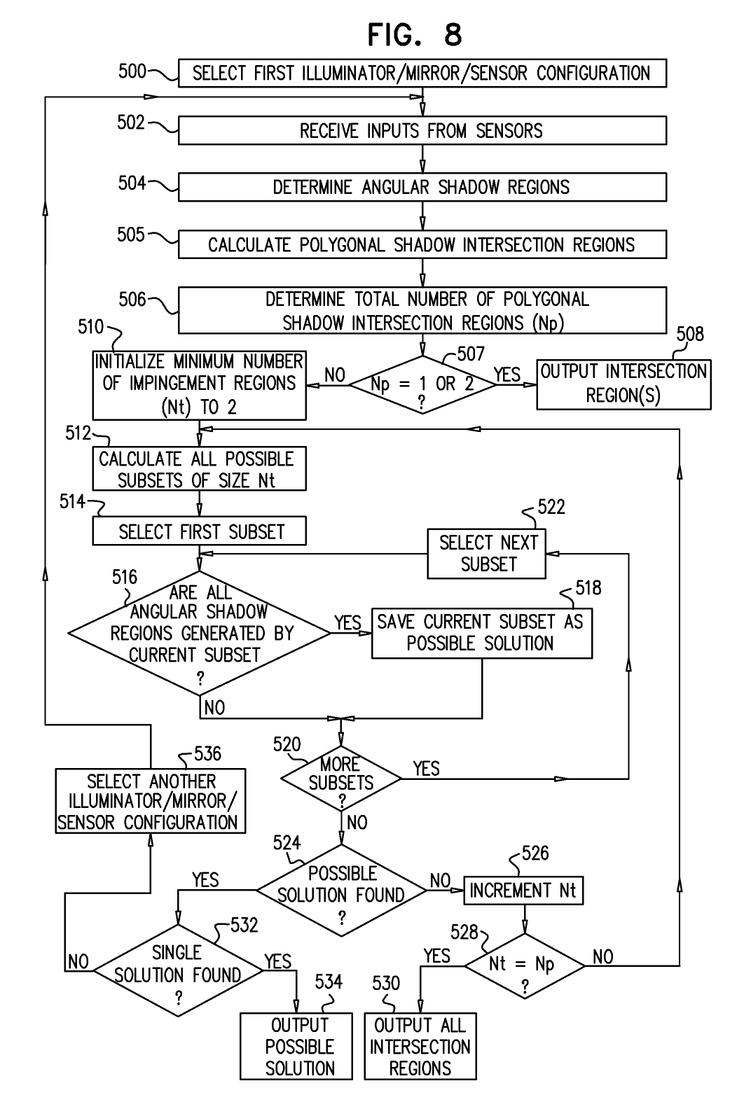

Reference is now made to FIG. 8, which is a simplified flowchart of another embodiment of the OISP functionality of the present invention, preferably for use with optical touch screen 100 of FIGS. 1-3. In the embodiment of FIG. 8, processor 170 is operative to utilize multiple illuminator/mirror/sensor configurations to provide a touch location output indication.

As seen in FIG. 8, in step 500, a processor, such as processor 170, is operative to select a first illuminator/mirror/sensor configuration. It is appreciated that the illuminator/mirror/sensor configuration may include actuation of all of illuminators 104, 106, 108 and 110, actuation of none of mirrors 162, 164, 166 and 168 and actuation of all of sensor assemblies 140, 142, 144 and 146, as described in reference to FIGS. 1-3. Alternatively, the illuminator/mirror/sensor configuration may include actuation of illuminators 104, 106 and 110, mirror 166 and sensor assemblies 140 and 142 only, which configuration is functionally equivalent to the touch screen of FIGS. 5-6, or may include actuation of illuminators 104 and 110, mirrors 164 and 166 and sensor assembly 140 only, which configuration is functionally equivalent to the touch screen of FIG. 7. As a further alternative, any suitable illuminator/mirror/sensor configuration may be selected by the processor.

The processor is operative, in step 502, to receive inputs from the selected sensor assemblies, and then, in step 504, uses the output of each sensor assembly selected to determine the angular shadow regions associated therewith. The processor is then operative, in step 505, to calculate polygonal shadow intersection regions, such as regions P1, P2 and P3 of FIG. 1, and, in step 506, to determine the total number of polygonal shadow intersection regions (Np) for this illuminator/mirror/sensor configuration.

As noted hereinabove with reference to FIG. 4, when the total number of polygonal shadow intersection regions, Np, is one or two, the one or two polygonal shadow regions correspond, respectively, to one or two object impingement locations. Therefore, in step 507, the processor tests if the total number of polygonal shadow intersection regions, Np, is equal to one or two. If the total number of polygonal shadow intersection regions, Np, is one, the processor is operative, in step 508, to output the corresponding region as the object impingement location, and if Np is two, the processor is operative, in step 508, to output the corresponding intersection regions as the two object impingement locations.

When Np is greater than two, the processor is then operative, in step 510 to initialize a counter for the minimum number of impingement regions (Nt) to 2. The processor, in step 512, calculates all possible subsets of size Nt of the polygonal shadow intersection regions.

The processor is then operative to test each of the subsets of possible object engagement locations of size Nt to find a subset such that, if object impingements occur in only the regions in that subset, the entire set of all potential polygonal shadow intersection regions is generated.

Thus, in step 514, the first subset is selected as the current subset. The current subset is then tested at step 516 to see if impingement at the intersection regions in the current subset generates all angular shadow regions generated in step 504. If all angular shadow regions generated in step 504 are generated by the current subset, the processor is operative, in step 518, to record the intersection regions identified by the current subset as a possible solution for the Nt object impingement locations.

The processor then checks, in step 520, if there are more subsets of size Nt to be tested. If there are more subsets of size Nt to be tested, the processor, in step 522, then selects the next subset to test and continues with step 516. If all subsets of size Nt have been tested, the processor then checks, at step 524, if any possible solutions have been found.

If no solutions have been found the processor then increments Nt, at step 526, and then tests if Nt is equal to Np at step 528. If Nt equals Np, the processor is operative, in step 530, to output all of the intersection regions identified as the Np object impingement locations. If Nt does not equal Np, the processor is operative to return to step 512 to then test all subsets of size Nt.

If, at step 524 possible solutions have been found, the processor then checks, at step 532, if a single solution has been found. If a single solution has been found, the processor then outputs, at step 534, the intersection regions identified as the possible solution as the Nt object impingement locations.

If at step 532 more than one solution has been found, the processor is then operative to select another illuminator/mirror/sensor configuration and to return to step 502 using the selected illuminator/mirror/sensor configuration. The solution sets are then compared and the solution set that is common to both configurations is output as the correct solution. It is appreciated that if multiple solution sets are common to both configurations additional illuminator/mirror/sensor configurations can be tried until a unique solution is determined.

It is appreciated that as the number of actual impingement events increases the possibility of multiple solution sets with a minimum number of actuation events increases. Changing configurations by selectably turning illuminators on and off enables every frame of the sensor assembly to consider a different configuration. The reconfigurable OISP functionality thus enables the touch panel to respond accurately to a greater number of impingement events with a very small overall reduction in the speed of the touch panel response.

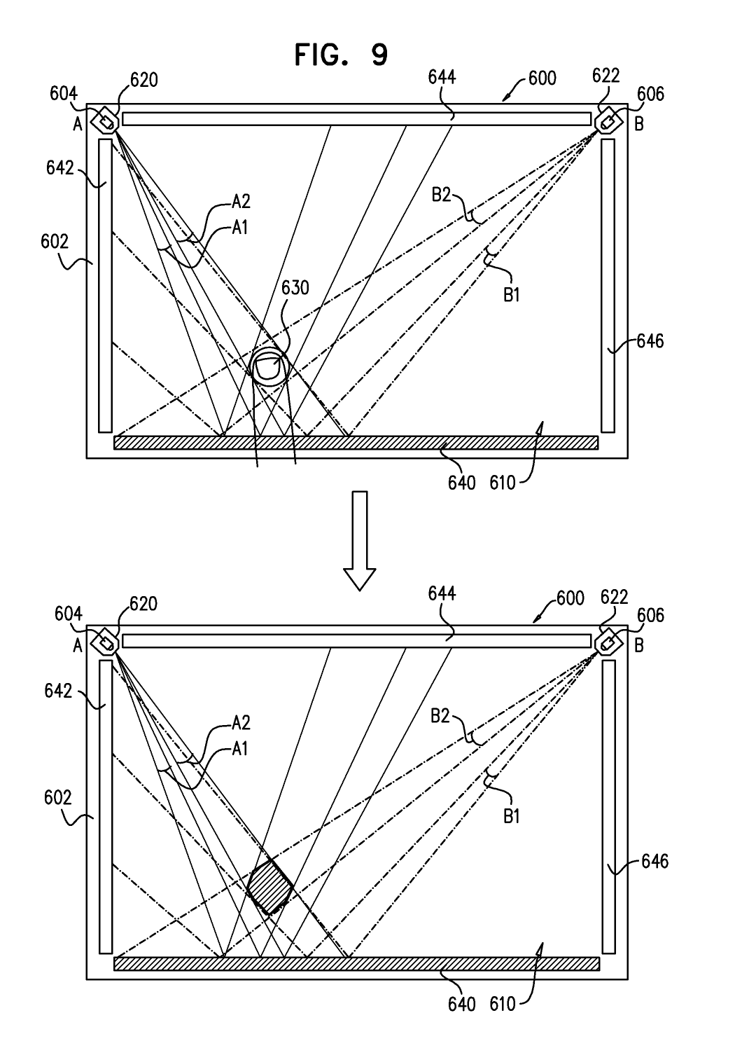

Reference is now made to FIG. 9, which is a simplified top view illustration of an optical touch panel constructed and operative in accordance with another preferred embodiment of the present invention.

As seen in FIG. 9, there is provided an optical touch panel 600 including a generally planar surface 602 and two illuminators 604 and 606, for illuminating a sensing plane 610 generally parallel to the generally planar surface 602. Each of illuminators 604 and 606 is preferably an LED or a diode laser, preferably an infrared laser or infrared LED.

Two light sensor assemblies 620 and 622, designated A and B, respectively, are provided for sensing the presence of at least one object in the sensing plane 610. Preferably, sensor assemblies 620 and 622 each employ linear CMOS sensors, such as an RPLIS-2048 linear image sensor, commercially available from Panavision SVI, LLC of One Technology Place, Horner, New York.

In accordance with a preferred embodiment of the present invention there is preferably provided a mirror 640 and preferably three 2-dimensional retro-reflectors 642, 644 and 646 disposed along edges of the generally planar surface 602. In accordance with a preferred embodiment of the present invention the mirror 640 is a 1-dimensional retro-reflector that acts as an ordinary mirror within the sensing plane but confines the reflected light to the sensing plane via the retro-reflecting behavior along the perpendicular axis.

It is appreciated that light from illuminators 604 and 606 directly hitting either one of the 2-dimensional retro-reflectors 642 or 646 will be directly reflected back towards the sensor assembly 620 or 622 adjacent to the respective illuminator 604 or 606. It is further appreciated that light hitting mirror 640 will be reflected onwards toward one of the 2-dimensional retro-reflectors 642, 644 or 646 and with then be retro-reflected back via mirror 640 towards the sensor assembly 620 or 622 adjacent to the respective illuminator 604 or 606.

Impingement of an object, such as a finger 630 or a stylus, upon touch surface 602 preferably is sensed by light sensor assemblies 620 and 622 preferably disposed at adjacent corners of planar surface 602. The sensor assemblies detect changes in the light emitted by the illuminators 604 and 606, and retro-reflected via reflectors 642, 644 or 646, possibly by way of mirror 640, produced by the presence of finger 630 in sensing plane 610. Preferably, sensor assemblies 620 and 622 are located in the same plane as the illuminators 604 and 606 and have a field of view with at least 90 degree coverage.

As described hereinabove with reference to FIGS. 5-7, the provision of at least one mirror results in the sensor assemblies sensing both the generated light from the illuminators as well as, additionally, the light reflected from the reflectors.

In accordance with a preferred embodiment of the present invention there is provided a processor (not shown) which receives inputs from sensor assemblies 620 and 622 and provides a touch location output indication.

Turning particularly to FIG. 9, there is seen a diagram of finger engagement with touch panel 600. It is appreciated that, while in the illustrated embodiment of FIG. 9, a single finger engagement is shown for simplicity, OISP functionality is operative to deal with up to any desired number of simultaneous object impingements.

FIG. 9 illustrates operation of object impingement shadow processing (OISP) functionality, preferably implemented by the processor. The OISP functionality is operative to distinguish between actual object engagements and spurious object engagements resulting from shadows sensed by sensor assemblies 620 and 622.

As seen in FIG. 9, the OISP functionality is operative to receive inputs from sensor assemblies 620 and 622 and to utilize the angular regions A1, A2, B1 and B2, of the respective fields of view of each of sensor assemblies 620 and 622 produced by engagement of finger 630 to define polygonal shadow intersection regions which constitute possible object engagement locations.

It is appreciated that there may be more polygonal shadow intersection regions, corresponding to possible object engagement locations, than there are actual object engagement locations.

The OISP functionality of the present invention is operative to identify the actual object engagement locations from among a greater number of potential object engagement locations.

Preferably, the OISP functionality is operative to find the smallest subset of possible object impingement locations from among the set of all potential polygonal shadow intersection regions, which subset is sufficient, such that if object impingements occur in only those regions, the entire set of all potential polygonal shadow intersection regions is generated.

It is appreciated that the OISP functionality described above and further hereinbelow with reference to FIG. 4, is operative to deal with up to any desired number of simultaneous object impingements.

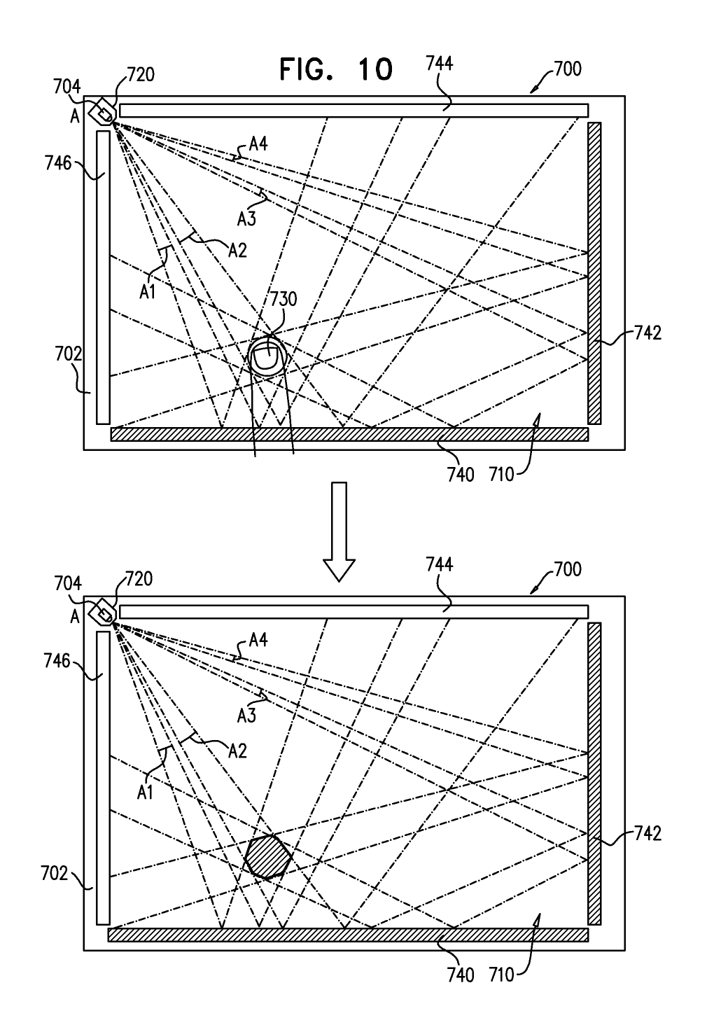

Reference is now made to FIG. 10, which is a simplified top view illustration of an optical touch panel constructed and operative in accordance with another preferred embodiment of the present invention.

As seen in FIG. 10, there is provided an optical touch panel 700 including a generally planar surface 702 and an illuminator 704 for illuminating a sensing plane 710 generally parallel to the generally planar surface 702. Illuminator 704 is preferably an LED or a diode laser, preferably an infrared laser or infrared LED.

A light sensor assembly 720, designated A, is provided for sensing the presence of at least one object in the sensing plane 710. Preferably, sensor assembly 720 employs a linear CMOS sensor, such as an RPLIS-2048 linear image sensor, commercially available from Panavision SVI, LLC of One Technology Place, Horner, New York.

In accordance with a preferred embodiment of the present invention there is preferably provided two mirrors 740 and 742 and preferably two 2-dimensional retro-reflectors 744 and 746 disposed along edges of the generally planar surface 702. In accordance with a preferred embodiment of the present invention, the mirrors 740 and 742 are 1-dimensional retro-reflector that act as ordinary mirrors within the sensing plane but confine the reflected light to the sensing plane via the retro-reflecting behavior along the perpendicular axis.

It is appreciated that light from illuminator 704 hitting mirrors 740 and 742 will be reflected onwards, either directly or via the other mirror toward one of 2-dimensional retro-reflectors 744 or 746 and with then be retro-reflected back via mirrors 740 and/or 742 towards the sensor assembly 720.

Impingement of an object, such as a finger 730 or a stylus, upon touch surface 702 preferably is sensed by light sensor assembly 720 preferably disposed at a corner of planar surface 702. Sensor assembly 720 detects changes in the light emitted by illuminator 704, and retro-reflected via reflectors 744 or 746, by way of mirrors 740 and 742, produced by the presence of finger 730 in sensing plane 710. Preferably, sensor assembly 720 is located in the same plane as illuminator 704 and has a field of view with at least 90 degree coverage.

As described hereinabove with reference to FIGS. 5-7, the provision of at least one mirror results in the sensor assemblies sensing both the generated light from the illuminators as well as, additionally, the light reflected from the reflectors.

In accordance with a preferred embodiment of the present invention there is provided a processor (not shown) which receives inputs from sensor assembly 720 and provides a touch location output indication.

Turning particularly to FIG. 10, there is seen a diagram of finger engagement with touch panel 700. It is appreciated that, while in the illustrated embodiment of FIG. 10, a single finger engagement is shown for simplicity, OISP functionality is operative to deal with up to any desired number of simultaneous object impingements.

FIG. 10 illustrates operation of object impingement shadow processing (OISP) functionality, preferably implemented by the processor. The OISP functionality is operative to distinguish between actual object engagements and spurious object engagements resulting from shadows sensed by sensor assembly 720.

As seen in FIG. 10, the OISP functionality is operative to receive inputs from sensor assembly 720 and to utilize the angular regions A1, A2, A3 and A4, of the respective fields of view of sensor assembly 720 produced by engagement of finger 730 to define polygonal shadow intersection regions which constitute possible object engagement locations.

It is appreciated that there may be more polygonal shadow intersection regions, corresponding to possible object engagement locations, than there are actual object engagement locations.

The OISP functionality of the present invention is operative to identify the actual object engagement locations from among a greater number of potential object engagement locations.

Preferably, the OISP functionality is operative to find the smallest subset of possible object impingement locations from among the set of all potential polygonal shadow intersection regions, which subset is sufficient, such that if object impingements occur in only those regions, the entire set of all potential polygonal shadow intersection regions is generated.

It is appreciated that the OISP functionality described above and further hereinbelow with reference to FIG. 4, is operative to deal with up to any desired number of simultaneous object impingements.

It will be appreciated by persons skilled in the art that the present invention is not limited by what has been particularly claimed hereinbelow. Rather the scope of the present invention includes various combinations and subcombinations of the features described hereinabove as well as modifications and variations thereof as would occur to persons skilled in the art upon reading the foregoing description with reference to the drawings and which are not in the prior art.

1. A touch panel comprising:
a generally planar surface;
at least two illuminators, for illuminating a sensing plane generally parallel to said generally planar surface;
at least one selectably actuable reflector operative, when actuated, to reflect light from at least one of said at least two illuminators;
at least one sensor for generating an output based on sensing light in said sensing plane; and
a processor which receives said output from said at least one sensor, and provides a touch location output indication.

2. A touch panel according to claim 1 and wherein:
said output from said at least one sensor indicates angular regions of said sensing plane in which light from said at least one illuminator is blocked by the presence of at least one object in said sensing plane; and
said processor comprises functionality operative to:
associate at least one two-dimensional shape to intersections of said angular regions;
choose a minimum number of said at least one two-dimensional shape sufficient to represent all of said angular regions; and
calculate at least one location of the presence of said at least one object with respect to said generally planar surface based on said minimum number of said at least one two-dimensional shape.

3. A touch panel according to claim 2 and wherein:
said at least one object comprises at least two objects;
said at least one two-dimensional shape comprises at least two two-dimensional shapes;
said minimum number of said at least one two-dimensional shape comprises at least two of said at least one two-dimensional shape; and
said at least one location comprises at least two locations.

4. A touch panel according to claim 2 and wherein said functionality is operative to select multiple actuation modes of said at least one selectably actuable reflector to provide said touch location output indication.

5. A touch panel according to claim 4 and wherein:
at least one of said at least two illuminators is selectably actuable; and
said functionality is operative to select corresponding multiple actuation modes of said at least one selectably actuable illuminator.

6. A touch panel according to claim 5 and wherein said functionality is operative to process outputs from selected ones of said at least one sensor corresponding to said multiple actuation modes of said at least one selectably actuable illuminator for providing said touch location output indication.

7. A touch panel according to claim 1 and wherein said touch location output indication includes a location of at least two objects.

8. A touch panel comprising:
a generally planar surface;
at least one illuminator for illuminating a sensing plane generally parallel to said generally planar surface;
at least one sensor for sensing light from said at least one illuminator indicating presence of at least one object in said sensing plane; and
a processor comprising functionality operative to:
receive inputs from said at least one sensor indicating angular regions of said sensing plane in which light from said at least one illuminator is blocked by the presence of said at least one object in said sensing plane;
associate at least one two-dimensional shape to intersections of said angular regions;
choose a minimum number of said at least one two-dimensional shape sufficient to represent all of said angular regions; and
calculate at least one location of the presence of said at least one object with respect to said generally planar surface based on said minimum number of said at least one two-dimensional shape.

9. A touch panel according to claim 8 and also comprising at least one reflector configured to reflect light from said at least one illuminator.

10. A touch panel according to claim 9 and wherein said at least one reflector comprises a 1-dimensional retro-reflector.

11. A touch panel according to claim 8 and wherein said at least one illuminator comprises an edge emitting optical light guide.

12. A touch panel according to claim 8 and wherein:
said at least one object comprises at least two objects;
said at least one two-dimensional shape comprises at least two two-dimensional shapes;
said minimum number of said at least one two-dimensional shape comprises at least two of said at least one two-dimensional shape; and
said at least one location comprises at least two locations.

13. A method for calculating at least one location of at least one object located in a sensing plane associated with a touch panel, the method comprising:
illuminating said sensing plane with at least one illuminator;
sensing light received by a sensor indicating angular regions of said sensing plane in which light from said at least one illuminator is blocked by the presence of said at least one object in said sensing plane;
associating at least one two-dimensional shape with intersections of said angular regions;
selecting a minimum number of said at least one two-dimensional shape sufficient to reconstruct all of said angular regions;
associating an object location in said sensing plane with each two-dimensional shape in said minimum number of said at least one two-dimensional shape; and
providing a touch location output indication including said object location of said each two-dimensional shape.

14. A method according to claim 13 and wherein:
said at least one object comprises at least two objects;
said at least one two-dimensional shape comprises at least two two-dimensional shapes;
said minimum number of said at least one two-dimensional shape comprises at least two of said at least one two-dimensional shape; and
said touch location object indication comprises said at least two locations of said at least two objects.

15. A touch panel comprising:
a generally planar surface;
at least one illuminator, for illuminating a sensing plane generally parallel to said generally planar surface;
at least one reflector operative to reflect light from said at least one illuminator;
at least one 2-dimensional retro-reflector operative to retro-reflect light from at least one of said at least one illuminator and said at least one reflector;
at least one sensor for generating an output based on sensing light in said sensing plane; and
a processor which receives said output from said at least one sensor, and provides a touch location output indication.

16. A touch panel according to claim 15 and wherein:
said at least one illuminator comprises two illuminators;
said at least one 2-dimensional retro-reflector comprises three 2-dimensional retro-reflectors; and
said at least one sensor comprises two sensors.

17. A touch panel according to claim 15 and wherein:
said at least one reflector comprises two reflectors; and
said at least one 2-dimensional retro-reflector comprises two 2-dimensional retro-reflectors.

18. A touch panel according to claim 15 and wherein said at least one reflector comprises a 1-dimensional retro-reflector.

19. A touch panel according to claim 15 and wherein:
said output from said at least one sensor indicates angular regions of said sensing plane in which light from said at least one illuminator is blocked by the presence of at least one object in said sensing plane; and
said processor comprises functionality operative to:
associate at least one two-dimensional shape to intersections of said angular regions;
choose a minimum number of said at least one two-dimensional shape sufficient to represent all of said angular regions; and
calculate at least one location of the presence of said at least one object with respect to said generally planar surface based on said minimum number of said at least one two-dimensional shape.

20. A touch panel according to claim 19 and wherein:
said at least one object comprises at least two objects;
said at least one two-dimensional shape comprises at least two two-dimensional shapes;
said minimum number of said at least one two-dimensional shape comprises at least two of said at least one two-dimensional shape; and
said touch location object indication comprises said at least two locations of said at least two objects.
